(19) United States
(12) Patent Application Publication
(10) Pub. No.: US 2025/0334666 A1
(43) Pub. Date: Oct. 30, 2025

(54) SHORT RANGE RADAR AND METHOD OF OPERATING A RADAR

(71) Applicant: STMicroelectronics International N.V., Geneva (CH)

(72) Inventor: Florian Etienne Baptiste Voineau, Grenoble (FR)

(21) Appl. No.: 19/098,511

(22) Filed: Apr. 2, 2025

(30) Foreign Application Priority Data
Apr. 29, 2024 (FR) FR2404470

(51) Int. Cl. G01S 7/03; G01S 7/285

(52) U.S. Cl. CPC G01S 7/032; G01S 7/285

(57) ABSTRACT

The present description concerns a radar apparatus comprising an electromagnetic wave receiver comprising an antenna for receiving electromagnetic waves coupled to an integrated circuit comprising a low-noise differential amplifier and an attenuation circuit interposed between the receiving antenna and the low-noise differential amplifier, the attenuation circuit comprising at least first, second, third, and fourth transistors.

### CROSS-REFERENCED TO RELATED APPLICATIONS

This application claims the priority benefit of French Patent Application No. FR2404470, filed on Apr. 29, 2024 entitled “Radar à courte portée et procédé de fonctionnement d′un radar,” which is hereby incorporated herein by reference to the maximum extent allowable by law.

### TECHNICAL FIELD

The present disclosure generally concerns short-range radars, especially ultra-wideband radars, and methods of operating short-range radars.

### BACKGROUND

Radar (radio detection and ranging) is a remote sensing device which uses electromagnetic waves to detect the presence and determine the position as well as the speed of objects, also called targets. The waves sent by the transmitter are reflected by the target, and the return signals (called radar echo) are captured and analyzed by the receiver. The distance is obtained due to the round trip time of the signal.

A pulsed radar is a radar which emits pulses of electromagnetic waves and then sets to a mode where it listens for the echo returned by the target. A pulsed radar may be an ultra-wideband radar, or UWB radar, when the transmitted signal comprises a very broad frequency spectrum, for example, according to the IEEE 802.15.4 standard.

The radar is said to be short-range when it is capable of detecting a target close to the receiver. This implies that the radar receiver should be capable of detecting an echo received shortly after the end of the transmission of a pulse. However, coupling phenomena between the transmitter and the receiver may make this detection difficult.

### SUMMARY

An embodiment overcomes all or part of the disadvantages of known short-range radars.

An embodiment provides a radar comprising an electromagnetic wave receiver comprising an electromagnetic wave receiving antenna coupled to an integrated circuit comprising a low-noise differential amplifier and an attenuation circuit interposed between the receiving antenna and the low-noise differential amplifier, the attenuation circuit comprising at least first, second, third, and fourth transistors.

According to an embodiment, the first, second, third, and fourth transistors are insulated-gate field-effect transistors.

According to an embodiment, the radar comprises a first symmetrical line between the receiving antenna and the attenuation circuit, and a second symmetrical line between the attenuation circuit and the low-noise differential amplifier.

According to an embodiment, the attenuation circuit comprises:
a first node connected to a first conductive track of the first symmetrical line;
a second node connected to a second conductive track of the first symmetrical line; and
a third node connected to a first conductive track of the second symmetrical line;
a fourth node connected to a second conductive track of the second symmetrical line;
the first transistor, having one of its drain and of its source coupled to the first node and having the other of its drain and of its source coupled to the third node, and having its gate receiving a first binary signal;
the second transistor, having one of its drain and of its source coupled to the first node and having the other of its drain and of its source coupled to the fourth node, and having its gate receiving a second binary signal;
the third transistor, having one of its drain and of its source coupled to the second node and having the other of its drain and of its source coupled to the third node, and having its gate receiving the second binary signal; and
the fourth transistor, having one of its drain and of its source coupled to the second node and having the other of its drain and of its source coupled to the third node, and having its gate receiving the first binary signal.

According to an embodiment, the radar further comprises a balun interposed between the receiving antenna and the attenuation circuit and connected to the first symmetrical line.

According to an embodiment, the radar further comprises an electromagnetic wave transmitter comprising an electromagnetic wave transmitting antenna, coinciding with or separate from the receiving antenna, and coupled to a control circuit configured to control the transmitting antenna, the control circuit being further configured to control the attenuation circuit.

According to an embodiment, in a first operating mode, the control circuit is configured to control the setting to the on state of the first and fourth transistors and the setting to the off state of the second and third transistors, and, in a second operating mode, the control circuit is configured to control the setting to the on state of the first, second, third, and fourth transistors.

According to an embodiment, each of the first, second, third, and fourth transistors comprises NMOS transistors in parallel, where N is an integer greater than or equal to 2.

An embodiment also provides a method of operation of the radar such as defined hereabove, comprising, in a first operating mode, the setting to the on state of the first and fourth transistors and the setting to the off state of the second and third transistors, and, in a second operating mode, the setting to the on state of the first, second, third, and fourth transistors.

According to an embodiment, the method comprises the switching from the first operating mode to the second operating mode, and the maintaining of the second operating mode for a determined time period, on control by the control circuit of the transmission of an electromagnetic wave pulse, and the switching from the second operating mode to the first operating mode at the end of the determined time period.

According to an embodiment, the method comprises, in the first operating mode, the setting to the on state of the N MOS transistors of the first and fourth transistors and the setting to the off state of the N MOS transistors of the second and third transistors, in the second operating mode, the setting to the on state of the N MOS transistors of the first, second, third, and fourth transistors, and comprises, in a third operating mode, the setting to the on state of the N MOS transistors of the first and fourth transistors, the setting to the on state of part of the N MOS transistor of the second and third transistors, and the setting to the off state of the rest of the N MOS transistors of the second and third transistors.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is an electrical diagram of an example of a radar;

FIG. 2 is a timing diagram of signals used by the radar of FIG. 1;

FIG. 3 is an electrical diagram of an example of a radar implementing a coupling reduction method;

FIG. 4 is an electrical diagram of another example of a radar implementing a coupling reduction method;

FIG. 5 is an electrical diagram of an embodiment of a radar;

FIG. 6 is an electrical diagram of an embodiment of an attenuation circuit for the radar of FIG. 5;

FIG. 7 is an electrical diagram of the attenuation circuit of FIG. 6, illustrating the current flow paths in a first operating mode;

FIG. 8 is an electrical diagram of the attenuation circuit of FIG. 6, illustrating the current flow paths in a second operating mode;

FIG. 9 shows timing diagrams of signals used by the radar of FIG. 5;

FIG. 10 illustrates the variation of the maximum transmission gain of the attenuation circuit of FIG. 6 as a function of the frequency of the signal received in the first operating mode and in the second operating mode;

FIG. 11 is a curve of the variation, according to the frequency of the received signal, of the difference between the maximum transmission gain of the attenuation circuit of FIG. 6 in the first operating mode and in the second operating mode;

FIG. 12 is an enlargement of FIG. 10 and FIG. 13 is an enlargement of FIG. 11;

FIG. 14 is a timing diagram of an example of an input signal of the attenuation circuit of FIG. 6, and FIG. 15 is a curve of the variation of the obtained output signal;

FIG. 16 is a curve of the variation of the gain of the attenuation circuit of FIG. 6 according to the power of the received signal;

FIG. 17 is an electrical diagram of another embodiment of the attenuation circuit of the radar of FIG. 5; and

FIG. 18 shows timing diagrams of signals used for the control of the attenuation circuit of FIG. 17.

### DETAILED DESCRIPTION OF ILLUSTRATIVE EMBODIMENTS

Like features have been designated by like references in the various figures. In particular, the structural and/or functional features that are common among the various embodiments may have the same references and may dispose identical structural, dimensional and material properties.

For clarity, only those steps and elements which are useful to the understanding of the described embodiments have been shown and are described in detail. In particular, the methods of transmitting electromagnetic waves by a pulsed radar are well known to those skilled in the art and are not described in detail.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as “front”, “back”, “top”, “bottom”, “left”, “right”, etc., or relative position qualifiers, such as “top”, “bottom”, “upper”, “lower”, etc., or orientation qualifiers, such as “horizontal”, “vertical”, etc., reference is made unless otherwise specified to the orientation of the drawings or to a . . . in a normal position of use.

Unless specified otherwise, the expressions “about”, “approximately”, “substantially”, and “in the order of” signify plus or minus 10% or 10°, preferably of plus or minus 5% or 5°. Further, there is called “binary signal” a signal which alternates between a first constant state, for example a low state, noted “0”, and a second constant state, for example a high state, noted “1”. The high and low states of different binary signals of a same electronic circuit may be different. In practice, the binary signals may correspond to voltages or to currents which may not be perfectly constant in the high or low state.

There is called MOS transistor an insulated-gate field-effect transistor or MOSFET (acronym for Metal-Oxide-Semiconductor Field-Effect Transistor). There is called UWB radar a pulsed radar for which the frequency spectrum of the transmitted pulse has a central frequency in the range from 6.5 GHz to 9.5 GHZ, and a bandwidth in the range from 500 MHz to 1.35 GHz. As an example, a UWB system follows the IEEE 802.15.4 standard.

FIG. 1 shows, partially and schematically, an example of a pulsed radar (apparatus) 10, for example a UWB radar.

Radar 10 comprises an electromagnetic wave transmitter 20 and an electromagnetic wave receiver 30. Transmitter 20 comprises an electronic transmitter circuit 21 with symmetrical outputs coupled to an electromagnetic wave transmitting antenna 22 via a balun 23. Balun 23 is an electrical circuit used to perform the coupling between a symmetrical transmission line originating from transmitter circuit 21 and an asymmetrical transmission line coupled to transmitting antenna 22. Receiver 30 comprises an electronic receiver circuit 31 with symmetrical inputs coupled to a receiving antenna 32 via a balun 33. Balun 33 is an electrical circuit used to perform the coupling between an asymmetrical transmission line coupled to receiving antenna 32 and a symmetrical transmission line originating from receiver circuit 31. Each balun 23, 33 may comprise a dual-winding transformer. In the example shown in FIG. 1, transmitting antenna 22 and receiving antenna 32 are separate. As a variant, transmitting antenna 22 and receiving antenna 32 may coincide.

Electronic transmitter circuit 21 comprises a pulse generator 24 delivering a signal IN to a power amplifier 25, which amplifies signal IN and delivers an analog signal TX to balun 23. Balun 23 transforms differential analog signal TX into an asymmetrical signal, which is transmitted by transmitting antenna 22 in the form of electromagnetic waves. Electronic receiver circuit 31 comprises a circuit 34 for processing the signals delivered by a low-noise amplifier 35. Receiving antenna 32 is sized to capture electromagnetic waves and to deliver an analog signal to balun 33, which transforms this analog signal into an analog differential signal RX transmitted to low-noise amplifier 35.

For a pulsed radar, electronic transmitter circuit 21 shapes the signals delivered to transmitting antenna 22 for the transmission of a pulse of electromagnetic waves of given duration, for example shorter than 1 ns, preferably shorter than 0.5 ns. The electromagnetic wave pulse reflects on an object present in the transmission field, and the reflected electromagnetic waves, also known as echoes, are captured by receiving antenna 32. Processing circuit 34 is then adapted to determining the distance which separates radar 10 from the object according to the time between the transmission of the electromagnetic wave pulse and the reception of the echo.

Radar 10 is generally designed to be able to detect an object located between a minimum distance and a maximum distance. For a short-range radar, the minimum distance is small, for example shorter than 50 cm, so that a first echo can reach receiving antenna 32 shortly after the transmission of the radar pulse by transmitting antenna 22. This first echo may result in a signal RX having a high amplitude that reception circuit 31 should be able to process.

Coupling phenomena may occur between transmitter 20 and receiver 30, which is schematically shown by an arrow C in FIG. 1.

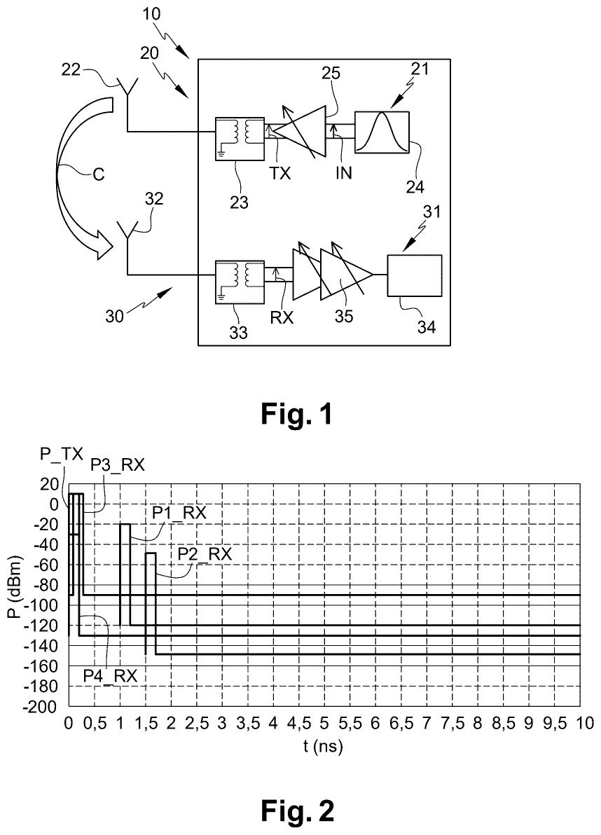

FIG. 2 shows curves of the variation of the average electrical power P of signal TX (curve P_TX) and of signal RX (curves P1_RX, P2_RX, P3_RX, and P4_RX) as a function of time, illustrating coupling phenomena. Each curve P_TX, _RX, P2_RX, P3_RX, and P4_RX comprises a pulse which is schematically represented by a square wave in FIG. 2. In FIG. 2, signals P1_RX, P2_RX, P3_RX, and P4_RX are substantially constant in the absence of an echo reception at different non-zero, albeit very low, levels and represent the signal unintentionally transmitted by the radar in the absence of a pulse to be transmitted.

The pulses of curves P1_RX and P2_RX correspond to echoes received by radar 10 for objects located at different distances from radar 10, or echoes originating from a same object but having followed different propagation paths. The pulse of signal P1_RX is obtained for an object close to radar 10, since the 1-ns duration between the beginning of the pulse of curve P_TX and the beginning of the reception of the pulse of curve P1_RX corresponds to an object distant by 15 cm in a direct line from radar 10.

Curve P4_RX illustrates a first type of coupling of radar 10, which corresponds to a coupling between transmitter circuit 21 and receiver circuit 31 when they are formed on a same integrated circuit, whereby the delivery of a signal TX pulse results in the quasi-simultaneous forming of a pulse of signal RX. Curve P3_RX illustrates a second type of coupling of radar 10, which corresponds to a coupling between transmitting antenna 22 and receiving antenna 32, which are generally close to each other, or even coincide, whereby the delivery of a pulse of signal TX also results in the quasi-simultaneous forming of a pulse of signal RX. As shown in FIG. 2, the electrical power of the coupling pulses may be high, in particular higher than 16 dBm, and in particular higher than the electrical power of a pulse corresponding to an echo on an object close to the radar.

Low-noise amplifier 35 then should receive the pulses due to coupling phenomena without being damaged, which may cause an oversizing of low-noise amplifier 35 with respect to the power levels that it receives in the case of true echoes. It is desirable to protect low-noise amplifier 35 from pulses due to coupling phenomena.

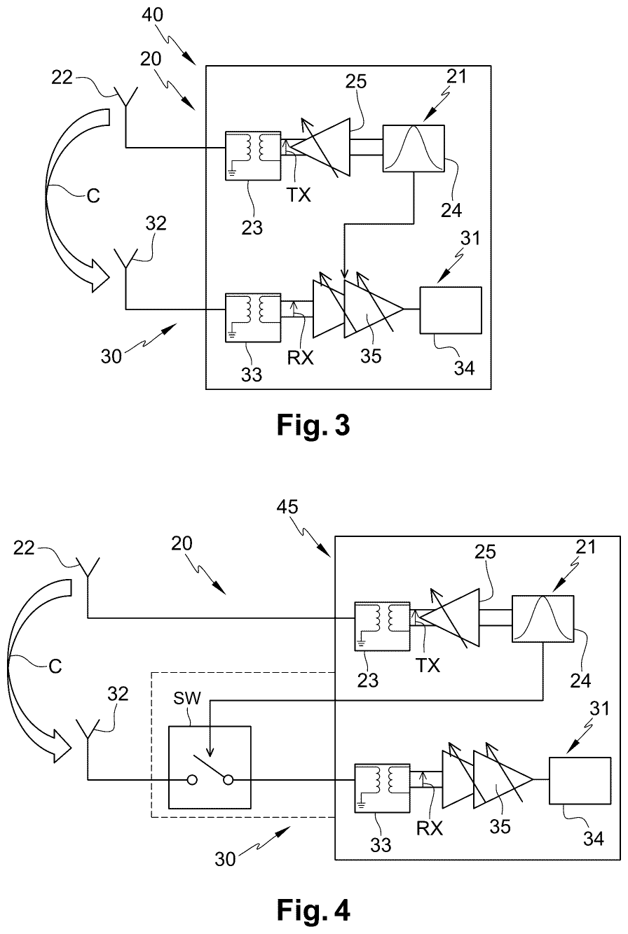

FIG. 3 is an electrical diagram of an example of a radar (apparatus) 40 implementing a method of reduction of coupling phenomena. The radar 40 shown in FIG. 3 comprises all the elements of the radar 10 shown in FIG. 1, pulse generator 24 being further adapted to controlling the temporary disabling of low-noise amplifier 35, in particular by temporarily stopping the power supply of low-noise amplifier 35. In particular, pulse generator 24 controls the disabling of low-noise amplifier 35 for a determined time period from the transmission of a pulse so that low-noise amplifier 35 does not transmit to processing circuit 34 the amplified pulses of signal RX which are due to coupling phenomena. Low-noise amplifier 35 should be enabled back before receiving antenna 32 receives the first echo. An attenuation of approximately 10 dB can generally be obtained by low-noise amplifier 35 within 1 ns. A disadvantage is that such an attenuation may not be sufficient to block pulses due to coupling phenomena.

FIG. 4 is an electrical diagram of an example of a radar (apparatus) 45 implementing another method of reduction of coupling phenomena. The radar 45 shown in FIG. 4 comprises all the elements of the radar 10 shown in FIG. 1, and further comprises a switch SW between receiving antenna 32 and balun 33. Pulse generator 24 is configured to control the turning off and the turning on of switch SW. In particular, pulse generator 24 controls the turning off of switch SW for a determined time period from the transmission of a pulse of signal IN, so that low-noise amplifier 35 does not receive the pulses of signal RX which are due to coupling phenomena. Switch SW has to be turned on before the reception of the first echo by receiving antenna 32. A disadvantage is that switch corresponds to an additional electronic component or electronic circuit in addition to receiver circuit 21. It may be difficult to obtain a suitable synchronization between the pulses supplied by pulse generator 24 and the off and on phases of switch SW.

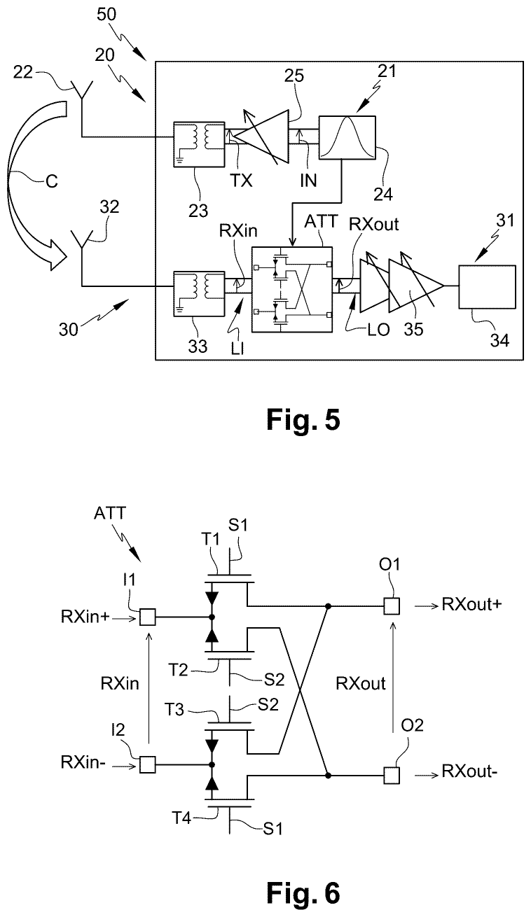

FIG. 5 is an electrical diagram of an embodiment of a radar (apparatus) 50 implementing a method of reduction of coupling phenomena.

The radar apparatus 50 shown in FIG. 5 comprises all the elements of the radar 10 shown in FIG. 1, receiver circuit 31 further comprising an attenuation circuit ATT coupling balun 33 to low-noise amplifier 35. Balun 33 delivers a signal RXin to attenuation circuit ATT and attenuation circuit ATT delivers a signal RXout to receiver circuit 31. According to an embodiment, attenuation circuit ATT and low-noise amplifier 35 correspond to an integrated circuit.

According to an embodiment, receiver circuit 31 is a differential circuit. In other words, receiver circuit 31 has a symmetrical structure. This means that signals RXin and RXout are transmitted by symmetrical lines. A symmetrical line is a group of two conductive tracks having exactly the same relation to ground, conveying an electrical signal from a source to a load. The signal being the potential difference between the two conductive tracks, it is spoken of a differential signaling. Signal RXin corresponds to a voltage between the two conductive tracks of a symmetrical line LI between balun 33 and attenuation circuit ATT, and signal RXout corresponds to a voltage between the two conductive tracks of a symmetrical line LO between attenuation circuit ATT and low-noise amplifier 35.

FIG. 6 shows an electrical diagram of attenuation circuit ATT.

Attenuation circuit ATT comprises:
a first input node I1, having a potential RXin+, and intended to be connected to the first conductive track, not shown, of the symmetrical line LI coupling attenuation circuit ATT to balun 33;
a second input node 12, having a potential RXin−, and intended to be connected to the second conductive track, not shown, of the symmetrical line LI coupling attenuation circuit ATT to balun 33;
a first output node O1, having a potential RXout+, intended to be connected to the first conductive track, not shown, of the symmetrical line LO coupling attenuation circuit ATT to low-noise amplifier 35;
a second output node 02, having a potential RXout−, intended to be connected to the second conductive track, not shown, of the symmetrical line LO coupling attenuation circuit ATT to low-noise amplifier 35;
a first MOS transistor T1, for example with an N channel, having its drain coupled, preferably connected, to node O1, having its source coupled, preferably connected, to node I1, and having its gate receiving a binary signal S1;
a second MOS transistor T2, for example with an N channel, having its drain coupled, preferably connected, to node O2, having its source coupled, preferably connected, to node I1, and having its gate receiving a binary signal S2;
a third MOS transistor T3, for example with an N channel, having its drain coupled, preferably connected, to node O1, having its source coupled, preferably connected, to node I2, and having its gate receiving binary signal S2; and
a fourth MOS transistor T4, for example with an N channel, having its drain coupled, preferably connected, to node O2, having its source coupled, preferably connected, to node I2, and having its gate receiving binary signal S1.

Signal RXin corresponds to the voltage between nodes I1 and 12, and signal RXout corresponds to the voltage between nodes O1 and O2.

According to an embodiment, MOS transistors T1, T2, T3, and T4 are identical.

In a first operating mode, attenuation circuit ATT is controlled so that signal RXout is substantially equal to signal RXin. In a second operating mode, attenuation circuit ATT is controlled so that signal RXout is substantially zero independently of signal RXin.

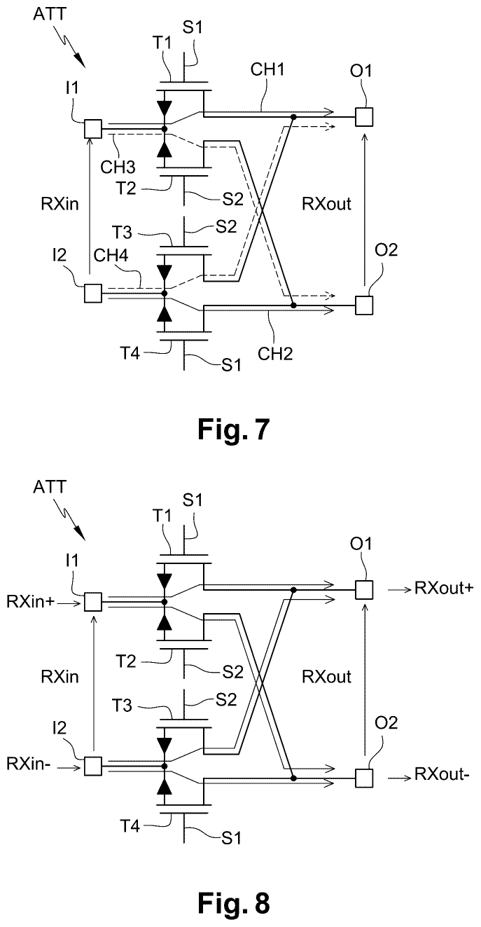

FIG. 7 shows attenuation circuit ATT in the first operating mode and illustrates the current flow paths. Signals S1 and S2 are delivered so that transistors T1 and T4 are on and so that transistors T2 and T3 are off. In the case where transistors T1, T2, T3, T4 are N-channel MOS transistors, in the first operating mode, signal S1 is in a high state and signal S2 is in a low state. Current can flow from node I1 to node O1 (path CH1) and from node I2 to node O2 (path CH2). Due to the parasitic capacitances of transistors T2 and T3, a very low current can flow from node I1 to node O2 (path CH3) and from node I2 to node O1 (path CH4). Potential RXout+ is substantially equal to potential RXin+ and potential RXout− is substantially equal to potential RXin− with a low attenuation due to the parasitic resistance of transistors T1 and T4. Voltage RXout is then substantially equal to voltage RXin with a low attenuation. Attenuation circuit ATT then behaves as an on switch having a low attenuation.

FIG. 8 shows attenuation circuit ATT in the second operating mode and illustrates the current flow paths. Signals S1 and S2 are delivered so that transistors T1, T2, T3, T4 are in the on state. In the case where transistors T1, T2, T3, T4 are N-channel MOS transistors, in the second operating mode, signals S1 and S2 are in the high state. Current can flow from node I1 to node O1 (path CH1), from node I2 to node O2 (path CH3), from node I1 to node O2 (path CH3), and from node I2 to node O1 (path CH4).

The potential RXin+ present at node I1 is substantially in phase opposition with the signal RXin− present at node I2. Everything happens as if a summing of potentials RXin+ and RXin− is performed at node O1 so that potential RXout+ is substantially zero, and a summing of potentials RXin+ and RXin− is performed at node O2 so that potential RXout− is substantially zero. Voltage RXout is thus substantially zero. The attenuation circuit then behaves as an off switch. A high attenuation of signal RXin is thus obtained in the second operating mode. Preferably, an attenuation of signal RXin higher than 30 dB is obtained in the second operating mode. This advantageously enables to block pulses due to coupling phenomena and to protect low-noise amplifier 35 from these pulses.

Transistors T1 and T4 are thus in the on state in the first operating mode and in the second operating mode. Signal S1 can thus be constant. Transistors T2 and T3 are in the off state in the first operating mode and in the on state in the second operating mode.

According to an embodiment, attenuation circuit ATT may be further controlled to a third operating mode where all transistors T1, T2, T3, and T4 are in the off state.

The time period for controlling the switching of attenuation circuit ATT from the first operating mode to the second operating mode is shorter than 1 ns, preferably shorter than 200 ps, for example in the range from 10 ps to 200 ps. Advantageously, the switching of attenuation circuit ATT between the first and second operating modes can be performed rapidly.

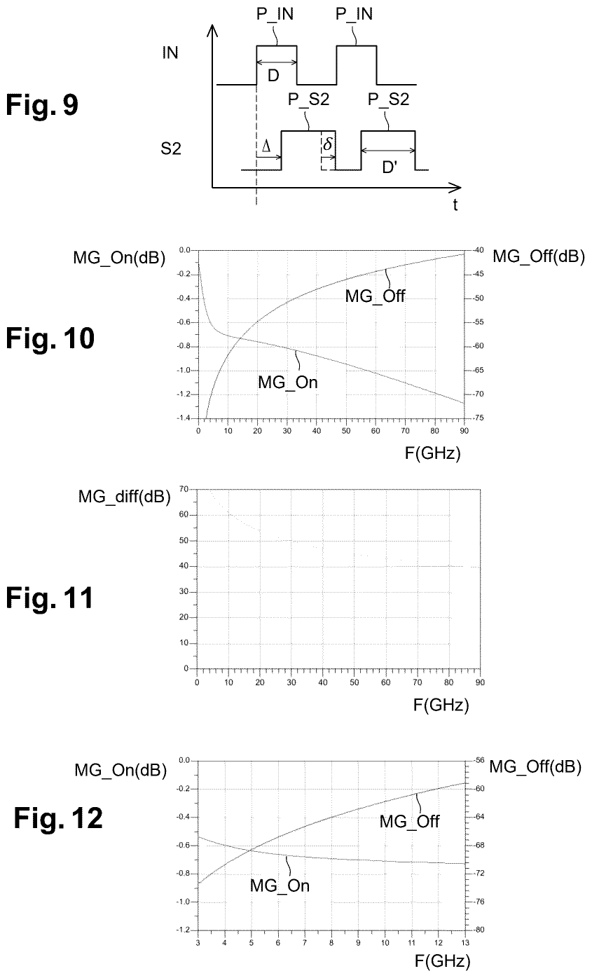

FIG. 9 shows timing diagrams of signal IN and of signal S2 for controlling the transistors T2 and T3 of attenuation circuit ATT. Signal IN comprises pulses P_IN for each transmission of an electromagnetic wave pulse, and signal S2 comprises a pulse P_S2 for each pulse of signal P_IN. According to an embodiment, pulses P_IN have a duration D and pulses P_S2 have a duration D′. Pulses P_S2 are characterized by two parameters Δ and δ. Parameter Δ corresponds to the time period between the rising edge of pulse P_IN and the rising edge of the corresponding pulse P_S2. Parameter δ corresponds to the difference between time periods D′ and D, time period D′ being longer than time period D. Time periods D, D′, Δ, and δ depend on the applications envisaged, and in particular on the radio frequency band used. According to an embodiment, time period D is in the range from 200 ps to 1 μs. According to an embodiment, time period D′ is in the range from D to 10 times D. According to an embodiment, time period Δ is in the range from 0 to D. According to an embodiment, time period δ is in the range from 0 to 9 times D.

Simulations have been carried out. The simulations include variations inevitable in integrated circuit design.

FIG. 10 is a curve of the variation MG_On of the maximum transmission gain of attenuation circuit ATT as a function of the frequency F of signal RXin in the first operating mode, and a curve of the variation MG_Off of the maximum transmission gain of attenuation circuit ATT as a function of the frequency F of signal RXin in the second operating mode. FIG. 11 is a curve of the variation MG_diff of the difference between variation curves MG_On and MG_Off. FIG. 12 is an enlargement of FIG. 10 and FIG. 13 is an enlargement of FIG. 11 for frequencies ranging from 3 GHz to 11 GHz, which correspond to most ultra-wideband applications. An attenuation of signal RXin greater than 40 dB is obtained in the second operating mode.

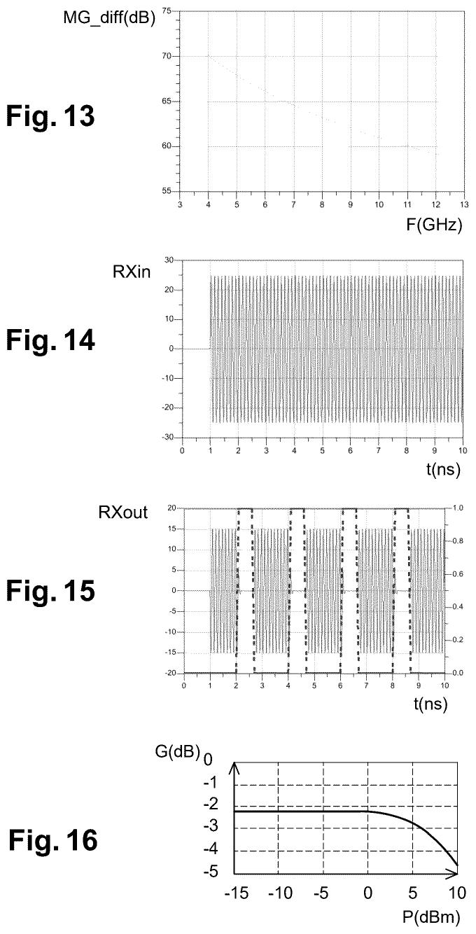

FIG. 14 is a timing diagram of the signal RXin delivered to the attenuation circuit of FIG. 6, and FIG. 15 is a curve of the variation of the signal RXout obtained in the case where signal RXin is a sinusoidal signal having a frequency equal to 8 GHz injected at time t equal to 1 ns. Signal RXin is transmitted with a low attenuation (it is passed from a 25-mV amplitude for signal RXin to approximately 15 mV for signal RXout), although, in the present simulation, there has been no impedance matching and 50-ohm default impedances have been used. At time t equal to 2 ns, the attenuation circuit is enabled for a time period much shorter than 1 ns. A very rapid and very significant attenuation can be observed for signal RXout.

FIG. 16 is a curve of the variation of the transmission gain G of attenuation circuit ATT as a function of the power P of signal RXin when the frequency of signal RXin is equal to 83.3 GHZ. A decrease in gain G is visible when power P is higher than 0 dBm.

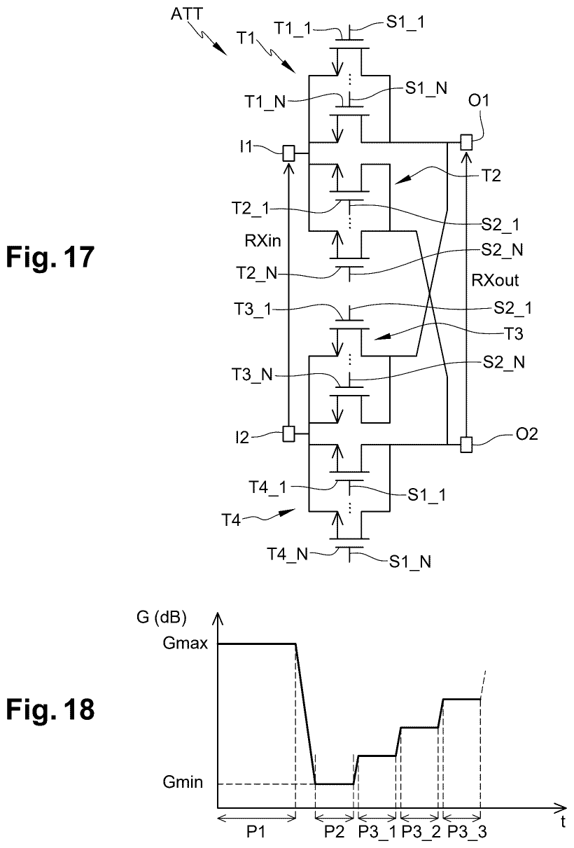

FIG. 17 is an electric diagram of another embodiment of attenuation circuit ATT. The attenuation circuit ATT shown in FIG. 17 has the same structure as the attenuation circuit ATT shown in FIG. 6, with the difference that transistor T1 is formed of N MOS transistors T1_1 to T1_N, for example, with an N channel, assembled in parallel, that transistor T2 is formed N MOS transistors T2_1 to T2_N, for example with an N channel, assembled in parallel, that transistor T3 is formed of N MOS transistors T3_1 to T3_N, for example with an N channel, assembled in parallel, and that transistor T4 is formed of N MOS transistors T4_1 to T4_N, for example with an N channel, assembled in parallel. More specifically, for each MOS transistor T1_i, i varying from 1 to N, the drain of transistor T1_i is coupled, preferably connected, to node 01, and the source of transistor T1_i is coupled, preferably connected, to node I1. For each MOS transistor T2_i, i varying from 1 to N, the drain of transistor T2_i is coupled, preferably connected, to node O2, and the source of transistor T2_i is coupled, preferably connected, to node I1. For each MOS transistor T3_i, i varying from 1 to N, the drain of transistor T3_i is coupled, preferably connected, to node O1, and the source of transistor T3_i is coupled, preferably connected, to node I2. For each fourth MOS transistor T4_i, i varying from 1 to N, the drain of transistor T4_i is coupled, preferably connected, to node O2, and the source of transistor T4_i is coupled, preferably connected, to node I2. The gate of each transistor T1_i, i varying from 1 to N, receives a gate control signal S1_i. The gate of each transistor T2_i, i varying from 1 to N, receives a gate control signal S2_i. The gate of each transistor T3_i, i varying from 1 to N, receives a gate control signal S2_i. The gate of each transistor T4_i, i varying from 1 to N, receives a gate control signal S1_i.

According to an embodiment, the method of controlling the attenuation circuit ATT shown in FIG. 17 may be identical to that described hereabove for the attenuation circuit ATT shown in FIG. 6. In this case, signals S1_1 to S1_N are identical, and signals S2_1 to S2_N are identical.

FIG. 18 shows a curve of the variation of the transmission gain G of the attenuation circuit ATT of FIG. 17, illustrating another embodiment in which, in a third operating mode, signals S2_1 to S2_N are not identical all the time.

In FIG. 18, a phase P1, a phase P2, and phases P3_1, P3_2, P3_3 have been shown. Phase P1 corresponds to the first above-described operating mode, in which transistors T1_1 to T1_N and transistors T4_1 to T4_N are in the on state, while transistors T2_1 to T2_N, and transistors T3_1 to T3_N are in the off state. Gain G is at a maximum value Gmax. In FIG. 18, phase P2 corresponds to the second above-described operating mode, in which transistors T1_1 to T1_N, transistors T2_1 to T2_N, transistors T3_1 to T3_N, and transistors T4_1 to T4_N are in the on state. Gain G is at a minimum value Gmin. In phases P3_1, P3_2, P3_3, gain G is between values Gmin and Gmax. In these phases P3_1, P3_2, P3_3, transistors T1_1 to T1_N and transistors T4_1 to T4_N are in the on state. Further, a number K of transistors T2_1 to T2_N are in the on state, K varying from 1 to N-1, the rest of transistors T2_1 to T2_N being in the off state, and the number K of transistors T3_1 to T3_N are in the on state and the rest of the transistors T3_1 to T3_N being in the off state. Gain G varies according to number K. The higher number K, the closer G is to Gmin. The lower number K, the closer G is to Gmax. Number K may differ from one phase P3_1, P3_2, P3_3 to the other.

Such an embodiment enables to achieve a moderate attenuation on signal RXin, without however completely blocking signal RXin. This is particularly advantageous to protect low-noise amplifier 35 in the case where signal RXin corresponds to the echo of a target close to radar 50 and may have high power. This enables in particular to use a highly sensitive low-noise amplifier 35, adapted to the detection of distant targets, also for the detection of close targets.

Various embodiments and variants have been described. Those skilled in the art will understand that certain features of these various embodiments and variants may be combined, and other variants will occur to those skilled in the art. In particular, in the above-described embodiments, attenuation circuit ATT comprises MOS transistors T1, T2, T3, T4. However, each MOS transistor may be replaced with another type of transistor, in particular a bipolar transistor or a modulated-doping field effect transistor, also called MODFET, or HEMT (High Electron Mobility Transistor).

Finally, the practical implementation of the described embodiments and variants is within the abilities of those skilled in the art based on the functional indications given hereabove.

What is claimed is:

1. A radar apparatus comprising:
an electromagnetic wave receiver comprising:
an electromagnetic wave receiving antenna; and
an integrated circuit coupled to the electromagnetic wave receiving antenna, and comprising:
a low-noise differential amplifier; and
an attenuation circuit interposed between the receiving antenna and the low-noise differential amplifier, the attenuation circuit comprising at least first, second, third, and fourth transistors.

2. The radar apparatus according to claim 1, wherein the first, second, third, and fourth transistors are insulated-gate field-effect transistors.

3. The radar apparatus according to claim 1, further comprising:
a first symmetrical line between the receiving antenna and the attenuation circuit; and
a second symmetrical line between the attenuation circuit and the low-noise differential amplifier.

4. The radar apparatus according to claim 3, wherein the attenuation circuit further comprises:
a first node connected to a first conductive track of the first symmetrical line;
a second node connected to a second conductive track of the first symmetrical line;
a third node connected to a first conductive track of the second symmetrical line; and
a fourth node connected to a second conductive track of the second symmetrical line.

5. The radar apparatus according to claim 4, wherein:
the first transistor has one of its drain and its source coupled to the first node the other of its drain and its source coupled to the third node, and its gate configured to receive a first binary signal;
the second transistor has one of its drain and its source coupled to the first node, the other of its drain and its source coupled to the fourth node, and its gate configured to receive a second binary signal;
the third transistor has one of its drain and its source coupled to the second node, the other of its drain and its source coupled to the third node, and its gate configured to receive the second binary signal; and
the fourth transistor has one of its drain and its source coupled to the second node, the other of its drain and its source coupled to the third node, and its gate configured to receive the first binary signal.

6. The radar apparatus according to claim 3, further comprising a balun interposed between the receiving antenna and the attenuation circuit, and connected to the first symmetrical line.

7. The radar apparatus according to claim 1, further comprising:
an electromagnetic wave transmitter comprising an electromagnetic wave transmitting antenna, coinciding with or separate from the receiving antenna; and
a control circuit coupled to and configured to control the transmitting antenna and the attenuation circuit.

8. The radar apparatus according to claim 7, wherein:
in a first operating mode, the control circuit is configured to control a setting of the first and fourth transistors to an on state, and a setting of the second and third transistors to an off state; and
in a second operating mode, the control circuit is configured to control a setting of the first, second, third, and fourth transistors to the on state.

9. The radar apparatus according to claim 1, wherein each of the first, second, third, and fourth transistors comprises N metal-oxide-semiconductor (MOS) transistors in parallel, where N is an integer greater than or equal to 2.

10. A method comprising:
in a first operating mode of a radar apparatus comprising an electromagnetic wave receiver including an electromagnetic wave receiving antenna and an integrated circuit coupled to the electromagnetic wave receiving antenna, the integrated circuit comprising a low-noise differential amplifier and an attenuation circuit interposed between the receiving antenna and the low-noise differential amplifier, the attenuation circuit comprising at least first, second, third, and fourth transistors, setting the first and fourth transistors to an on state, and setting the second and third transistors to an off state; and
in a second operating mode of the radar apparatus, setting the first, second, third, and fourth transistors to the on state.

11. The method according to claim 10, further comprising coupling, by a balun, between an asymmetrical transmission line of the receiving antenna and a symmetrical transmission line of the attenuation circuit.

12. The method according to claim 10, wherein the radar apparatus further comprises an electromagnetic wave transmitter comprising an electromagnetic wave transmitting antenna, coinciding with or separate from the receiving antenna, and a control circuit coupled to and configured to control the transmitting antenna and the attenuation circuit, and the method further comprises:
switching from the first operating mode to the second operating mode;
controlling, by the control circuit, transmission of an electromagnetic wave pulse;
maintaining the second operating mode for a predetermined time period in accordance with the controlling; and
switching from the second operating mode to the first operating mode at an end of the predetermined time period.

13. The method according to claim 12, further comprising coupling, by a balun, between a symmetrical transmission line of a transmitter circuit and an asymmetrical transmission line of the transmitting antenna.

14. The method according to claim 10, wherein each of the first, second, third, and fourth transistors comprises N metal-oxide-semiconductor (MOS) transistors in parallel, N being an integer greater than or equal to 2, and the method comprises:
in the first operating mode, setting the N MOS transistors of the first and fourth transistors to the on state, and setting the N MOS transistors of the second and third transistors to the off state;
in the second operating mode, setting the N MOS transistors of the first, second, third, and fourth transistors to the on state; and
in a third operating mode, setting the N MOS transistors of the first and fourth transistors to the on state, setting part of the N MOS transistors of the second and third transistors to the on state, and setting a rest of the N MOS transistors of the second and third transistors to the off state.

15. The method of claim 10, further comprising controlling the first and fourth transistors with a first binary signal, and controlling the second and third transistors with a second binary signal.

16. A radar apparatus comprising:
an electromagnetic wave receiver comprising:
an electromagnetic wave receiving antenna; and
an integrated circuit coupled to the electromagnetic wave receiving antenna, and comprising:
a low-noise differential amplifier; and
an attenuation circuit interposed between the receiving antenna and the low-noise differential amplifier, the attenuation circuit comprising at least first, second, third, and fourth transistors;
an electromagnetic wave transmitter comprising:
an electromagnetic wave transmitting antenna, coinciding with or separate from the receiving antenna;
a power amplifier coupled to the transmitting antenna; and
a transmitter circuit coupled to the power amplifier; and
a control circuit coupled to and configured to control the transmitting antenna and the attenuation circuit.

17. The radar apparatus according to claim 16, further comprising:
a first symmetrical line between the receiving antenna and the attenuation circuit;
a second symmetrical line between the attenuation circuit and the low-noise differential amplifier;
a third symmetrical line between the transmitter circuit and the power amplifier; and
a fourth symmetrical line between the power amplifier and the transmitting antenna.

18. The radar apparatus according to claim 17, further comprising:
a first balun interposed between the receiving antenna and the attenuation circuit; and
a second balun interposed between the power amplifier and the transmitting antenna.

19. The radar apparatus according to claim 16, wherein:
in a first operating mode, the control circuit is configured to control a setting of the first and fourth transistors to an on state, and a setting of the second and third transistors to an off state; and
in a second operating mode, the control circuit is configured to control a setting of the first, second, third, and fourth transistors to the on state.

20. The radar apparatus according to claim 16, wherein each of the first, second, third, and fourth transistors comprises N metal-oxide-semiconductor (MOS) transistors in parallel, where N is an integer greater than or equal to 2.
